(19) United States
(12) Patent Application Publication
(10) Pub. No.: US 2011/0184623 A1
(43) Pub. Date: Jul. 28, 2011

(54) DIFFERENTIATED TAKEOFF THRUST METHOD AND SYSTEM FOR AN AIRCRAFT

(76) Inventor: Robertus Gerardus De Boer, Heiloo (NL)

(21) Appl. No.: 13/122,451

(22) PCT Filed: Oct. 7, 2009
(86) PCT No.: PCT/NL09/50602

§ 371 Date: Apr. 4, 2011

(30) Foreign Application Priority Data
Oct. 7, 2008 (NL) 2002064

(51) Int. Cl. G05D 1/00; G06F 19/00

(52) U.S. Cl. 701/99

(57) ABSTRACT

A method for propelling an aircraft (1), wherein the engines (M1-M4) of the aircraft (1) with three or more engines are controlled in such a manner that the aircraft (1) can apply the current method to take off from a short and/or slippery runway (A) with a higher takeoff weight than with existing methods. The invention aims to improve the efficiency of flight operation. The invention enables the aircraft to take off with a higher payload and/or with more fuel. To this end, during a takeoff of the aircraft (1) a symmetrical thrust is applied, wherein at least one engine (M1-M4) provides less thrust (F1-F4) than the maximum thrust of this engine (M1-M4), and wherein at least one engine (M1-M4) mounted further from the symmetry plane of the aircraft provides less thrust than an engine (M2, M3) mounted closer to or on the symmetry plane.

### TECHNICAL FIELD

The present invention relates to a method for propelling an aircraft comprising three or more engines for propelling the aircraft, and processing means that are coupled to the engines, wherein the processing means are arranged to control one or more engines according to a preset thrust level, wherein a preset thrust level represents a desired thrust level of one engine or more engines.

### BACKGROUND OF THE PRIOR ART

U.S. Pat. No. 5,927,655 discloses a method for controlling the propulsion of an aircraft with multiple engines. A control device is equipped to intervene in the control of an outer engine in the event that a failure occurs in an opposing outer engine.

### SUMMARY OF THE INVENTION

According to the present invention a method is provided, as defined above, wherein during a takeoff of the aircraft a symmetrical thrust is applied, wherein at least one engine provides less thrust than the maximum thrust of this engine, and wherein at least one engine mounted further from the symmetry plane of the aircraft (hereby designated as the plane through the longitudinal axis and the top axis of the aircraft) provides less thrust than an engine mounted closer to or on the symmetry plane. In this manner, the aircraft may take off from a short and/or a slippery runway with a higher takeoff weight than with hitherto known methods. The invention aims to improve the efficiency of the flight operation. With the invention, the aircraft may depart with more payload, enabling more yield from the flight, and/or more fuel, thereby increasing the flight range.

A maximum permissible takeoff weight of an aircraft is the most restricting weight of the maximum certified takeoff weight and a number of situation-dependent operating limits, such as a runway-length limited takeoff weight, an obstacle limited takeoff weight, a braking energy limited takeoff weight, etc. With a maximum permissible takeoff weight of less than the maximum certified takeoff weight a flight may be restricted with regard to its payload and/or flight range. On a short and/or slippery runway surface, the runway-length limited takeoff weight generally determines the maximum permissible takeoff weight.

On a short and/or a slippery runway the directional controllability of the aircraft affects the takeoff weight limited by the runway-length: a rudder must undergo a sufficiently fast circumfluous airflow to be able to neutralize the effects of a loss of thrust in the event of an engine failure during a takeoff. The minimum control speed wherein the aircraft in takeoff configuration may still be held on the runway in the event of an engine failure of the most unfavourable engine whilst maximum thrust is applied to the operative engines, i.e. the V_{mcg}, or can safely fly, i.e. the V_{mca}, affects the takeoff speeds used on a short and/or a slippery runway. The V_{mcg}, the minimum control speed on the ground, represents a lower threshold for the decision speed during an aircraft takeoff, the V₁; at a speed lower than V_{mcg} it is possible that the aircraft, once committed to takeoff, cannot be controlled safely on the runway and that the takeoff must therefore be aborted upon detecting an engine failure. The V_{mca}, the minimum control speed in the air, forms, with increased increments, a lower threshold for the rotation speed, Vᵣ, and the minimum air speed, the V₂ speed.

During an aircraft takeoff, a balanced takeoff is preferably applied: the V₁ is determined in such a manner that the required runway-length in the event of an aborted takeoff at (or just after) V₁ is equal to the required runway-length for a committed takeoff following an engine failure when (or just before) V₁ is reached, wherein the aircraft passes a legally prescribed altitude. A balanced takeoff results in a minimum required runway-length at a takeoff weight and a (predetermined) thrust level. During an aircraft takeoff the lowest possible takeoff speeds Vᵣ and V₂ are preferably used in order to keep the required runway-length as short as possible with a normal or a committed takeoff. The minimum V₂ and the derivative thereof, Vᵣ, is determined by the weight-dependent stall speed augmented by a legally prescribed incremental increase.

For the determination of a required runway-length and the minimum control speeds, the maximum takeoff thrust method is applied during the certification of the aircraft, wherein the maximum engine thrust is selected during a takeoff. The maximum thrust of an engine may be the certified nominal thrust during a takeoff (in aviation known as “rated takeoff thrust”), adjusted where necessary for, among other things, installation losses and/or atmospheric conditions, or a maximum selected thrust level in an engine controller lower than the rated thrust of the engine.

Where the available length of the runway is in excess of the required runway-length, the thrust of the engines during takeoff is preferably reduced in order to decrease engine load and thus engine maintenance. During a takeoff according to this flexible takeoff thrust method (in aviation known as “flexible takeoff thrust” or “reduced takeoff thrust”) the takeoff speeds remain based upon the minimum control speeds associated with a maximum takeoff thrust method, wherein the pilot, during a takeoff, can at all times select thrust in excess of the selected reduced thrust, without endangering the controllability of the aircraft.

With a V₁ limited by V_{mcg}, a takeoff can no longer be balanced: the required runway-length in the event of an aborted takeoff at V₁ is greater than the required runway-length for a committed takeoff after an engine failure at (or just before) V₁, as a result of which the runway-length cannot be used to its maximum. With a Vᵣ and/or V₂ limited by V_{mca}, the required runway-length for a normal or a committed takeoff is longer than is required for a takeoff off at a V₂ limited by the stall speed. Up to a given takeoff weight, i.e. the runway-length limited takeoff weight, a takeoff with a V_{mcg} or V_{mca} limited takeoff speed means that the thrust can be decreased less when a flexible takeoff thrust method is applied. With a scheduled takeoff weight in excess of the runway-length limited takeoff weight, the scheduled takeoff weight must be reduced to the runway limited takeoff weight and the aircraft can carry less than the scheduled payload and/or less than the planned fuel load.

On a slippery runway, for example caused by rainfall or contamination such as snowfall, the runway-length limited takeoff weight is (further) reduced. Because the friction of the aircraft tires with the runway is less on a slippery runway, possibly in conjunction with hydrodynamic effects such as aquaplaning, the maximum available braking action decreases in the event of an aborted takeoff. In order to balance a takeoff (optimally) the V₁ must therefore be (further) reduced, as a result of which the V₁ is already limited by V_{mcg} at a lower takeoff weight, and a lower runway-length limited takeoff weight can result than on a dry runway with no contamination.

A known method for departing from a short and/or slippery runway with a higher takeoff weight is the derated takeoff thrust method (known in aviation as the “derated takeoff thrust”). In case of a derated takeoff, the thrust of each engine is equally reduced and limited during the takeoff. As a result of the reduced thrust of the most unfavourable engine, less force needs to be exerted by the rudder in order to keep the aircraft safely on the runway or to keep the aircraft airborne during a committed takeoff following an engine failure. This reduced force on the rudder requires a lower circumfluous airflow speed at maximum deflection and this therefore results in lower minimum control speeds V_{mcg} and V_{mca}. In the case of the derated takeoff thrust method, the takeoff speeds are based on the minimum control speeds corresponding to the derated thrust, as a result of which, during takeoff, the pilot is not permitted to select more thrust than the derated thrust level so as not to put the controllability of the aircraft at risk.

The advantage of the derated takeoff thrust method is that a V₁ limited by V_{mcg}-rated (i.e. V_{mcg} based on maximum thrust of the engines) may be reduced down to the V_{mcg}-derated (the V_{mcg} based upon the limited thrust of the engines), as a result of which the runway-length required for the acceleration to V₁ plus the runway-length required for the aborted takeoff at V₁ can decrease. In addition, with the derated takeoff thrust method a Vᵣ and or V₂ limited by a V_{mca}-rated speed may be reduced respectively to the Vᵣ and/or V₂ corresponding to V_{mca}-derated, which decreases the runway-length required during a normal and a committed takeoff. The disadvantage of the derated takeoff thrust method is that the acceleration of the aircraft decreases because of the reduced thrust so that the runway-length required increases on a normal takeoff and on a committed takeoff in the event of an engine failure. Compared to the maximum thrust method, when using the derated takeoff thrust method from a short and/or slippery runway, the runway-length limited takeoff weight increases more due to the reduction of the V₁, Vᵣ and/or V₂, than it decreases due to the reduced thrust, thus increasing the runway-length limited takeoff weight.

Therefore, it is the objective of the present invention to provide a method by which an aircraft with three or more engines can take off with a higher weight from a short and/or slippery runway than with the existing methods. This objective is achieved by enabling the aircraft engines to provide differentiated symmetrical thrust during an aircraft takeoff, wherein the preset thrust level of an engine mounted further from the symmetry plane of the aircraft is less than the preset thrust level of an engine mounted closer to or on the symmetry plane. The method according to the present invention will hereafter be designated as the “differentiated takeoff thrust method.”

Aircraft engines are usually mounted symmetrically in relation to the symmetry plane of the aircraft, each individual engine providing an equal amount of maximum thrust. Failure of an engine mounted further from symmetry plane causes a greater destabilizing effect than an engine mounted closer to or on the symmetry plane because of the thrust of the operative symmetrical engine on the aircraft. The method according to present invention is a further development of the derated takeoff thrust method: it applies a reduction of the V_{mcg} and the V_{mca} by reducing the thrust of the most unfavourably mounted engine(s), but in the more favourably mounted engine(s) the thrust is adjusted to the effects that a possible engine failure might have on the controllability of the aircraft. The effect on the controllability, and thus on the V_{mcg} and V_{mca}, of an engine failure is largely determined by the thrust of the engine in conjunction with its distance to the symmetry plane. By adapting the selected thrust level of an engine or combination of engines to the distance of the engine or combination of engines to the symmetry plane during the takeoff configuration of the aircraft, wherein an engine mounted further from the symmetry plane provides less thrust than an engine(s) mounted closer to or on the symmetry plane, the V_{mcg} and V_{mca} remain based upon the most unfavourable engine, but due to the increased thrust of the engine(s) mounted closer to or on the symmetry plane, more cumulative thrust (the combined thrust of all engines) is provided than by the derated takeoff thrust method, at least during a part of the takeoff. Applying the increased cumulative thrust enables a higher runway-length limited takeoff weight and thus more payload and/or fuel can be carried compared to the maximum or derated takeoff thrust method.

In one embodiment, when determining the thrust level to be applied by an engine or combination of engines during takeoff, the pilot uses an input panel for selecting a preset takeoff method, wherein the preset takeoff method represents the desired takeoff method of the device during the takeoff configuration and wherein one of the takeoff methods that can be selected is the differentiated takeoff thrust method. In one embodiment, the pilot uses the input to determine whether the differentiated takeoff thrust method is to be applied during takeoff with a fixed differentiated thrust setting for the engines. In one embodiment, an input panel for an input of a preset thrust level for an engine or an combination of engines is used, wherein the preset thrust level represents the desired thrust level of an engine or a combination of engines during a takeoff.

In one embodiment, a preset thrust level of an engine or combination of engines is determined automatically by a processing unit based upon an input on an input panel, data from an aircraft system and/or data from a data file with the use of, but not necessarily limited thereto, a parameter such as an aircraft payload, a runway-length, an obstacle in a takeoff climb path, a flap position, a runway condition, an air pressure, a wind and/or a temperature. In one embodiment, in order to obtain one of these parameters, use is made of a computerized data file, an aircraft weight-determination system, an air data computer and/or a pitot-static system. In one embodiment the automated determination of a preset thrust level is accompanied by an automatic determination of a minimum control speed and/or a takeoff speed to be applied for the takeoff.

In one embodiment an automated determination of a preset thrust level of an engine or combination of engines is controlled by a processing unit on board the aircraft. In an alternative embodiment an automated determination of a preset thrust level of an engine or combination of engines is controlled by a remote processing unit, wherein in one embodiment use is made of a wireless data communication.

Control of (an)(the) engine(s) of an aircraft occurs by means of (a) throttle lever(s). In modern aircraft, a throttle lever controls an engine control unit of an engine, either through a processing unit or otherwise. An engine control unit of an engine independently controls the individual engine units, such as fuel injection and air valves, according to a command originating from the throttle lever or through a processing unit mounted between a throttle lever and an engine control module, in such a manner that the desired thrust is delivered (as much as possible).

For the control of the engines during a takeoff of an aircraft, for example, an automated device is used. An automated device for controlling the engines of an aircraft by means of throttle levers (in aviation known as “auto throttle”) is based upon one of two basic configurations of the throttle levers. In the first basic configuration, the continuously variable throttle lever, the throttle lever is adjustable across the entire range and the thrust of an engine related to a throttle lever is permanently coupled to the position of the throttle lever (in aviation known as the “thrust lever position”); the position of the throttle lever is transmitted to the engine control module whereupon the engine control module controls the thrust of an engine based on the position of the engine throttle lever. In this basic configuration, during a takeoff with a preset thrust level, a preset thrust level is input by the pilot on an input panel before the takeoff, whereupon a control system controls, on a command given by the pilot, for example, by activating a switch, a drive mechanism connected to the throttle lever so that the engines of the aircraft deliver the preset thrust during the takeoff. In the second basic configuration, the discrete selectable throttle lever, the throttle lever can be set to a discrete number of positions by the pilot and the thrust of an engine or combination of engines related to the throttle lever is coupled to the predetermined or fixed thrust level or mode corresponding to the position of the throttle lever. A processing unit controls the engine control module by means of a preselected thrust level or mode indicated by the throttle lever. In this basic configuration, during a takeoff with a preset thrust level, a preset thrust level is input by the pilot on an input panel coupled to the processing unit before takeoff, whereupon during the takeoff, the throttle lever(s) is/are set to the corresponding preset thrust-related position(s) by the pilot, after which the processing unit controls the engine control(s) in such a manner that the respective engine(s) provide(s) the preset thrust during the takeoff. Various hybrid arrangements of both basic configurations and modifications are conceivable and applied.

In an aircraft with (a) discrete adjustable throttle lever(s) a device according to the present invention is implemented in one embodiment in the software of a processing unit and/or input panel related to the automatic control of the engines.

In existing systems based upon a continuously adjustable throttle lever, the transmission between the throttle lever position and the thrust level of the engine is determined by means of a permanent transfer function. In a device according to the present invention, the preset thrust levels of the individual engines can be different during an aircraft takeoff, which, in the case of existing devices results in different throttle lever positions during an aircraft takeoff. A pilot is accustomed to throttle levers that have (almost) the same position during an aircraft takeoff. These equal throttle lever positions enable the pilot to quickly and equally select a required thrust level for the takeoff, increase these levels, for example, in a wind shear, or reduce these levels in the event of an aborted takeoff.

In one embodiment with a device according to the present invention having a continuously adjustable throttle lever, specially modified software is applied for the automated control unit coupled to the throttle levers for the control of the engines and/or an input panel coupled to the automated control unit, wherein unequal throttle lever positions are possible during a takeoff.

In one embodiment, a device according to the present invention having a continuously adjustable throttle lever uses an adjustable transmission between the position of a throttle lever and the thrust of an engine. In this embodiment, the transmission between the position of a throttle lever and the thrust level of an engine is configured in such a manner that during an aircraft takeoff according to the present method, the throttle lever positions during the takeoff are equal, at least practically equal, when the thrust of the engines is unequal. In one embodiment, a predetermined transmission between the position of the throttle lever and the thrust of an engine is dependent on a preset thrust level. In one embodiment a predetermined transmission between the position of the throttle lever and the thrust of an engine is dependent on an input on an input panel. In one embodiment, a predetermined transmission is used by the engine control module(s) of an engine or combination of engines. In one embodiment, a predetermined transmission in a processing unit between a throttle lever and an engine control module is used.

In one embodiment, a device according to the present invention is applied in order to limit the thrust of an engine during a takeoff. In this embodiment, each position of a throttle lever beyond the position required for the preset thrust results in a thrust level equal to the preset thrust level. Consequently, the throttle levers can be set by the pilot to their extreme (maximum) positions so that a derated engine provides no more thrust than the preset thrust, thus enabling all throttle levers to be moved uniformly during a takeoff.

In one embodiment, a preset thrust level is used by an engine control module of an engine to be derated in such a manner that the respective engine delivers no more thrust during a takeoff than the preset thrust. In one embodiment, a preset thrust level in a processing unit between a throttle lever and an engine control module is applied, wherein the engine corresponding to the engine control module delivers no more thrust during the takeoff than the preset thrust.

In one embodiment with a device according to the present invention, an input means is applied in order to adjust a preset thrust level of an engine to the maximum thrust level of the engine during a takeoff or subsequent climb procedure. Circumstances may occur which require the maximum thrust of all engines, such as a strong wind shear, microburst, or a potential collision, wherein the risk of (temporary) loss of control due to a possible but unlikely engine failure may be considered by the pilot to have a lower priority than the circumstances encountered at that particular moment. In this case, the speed of the aircraft may already be found to be above the minimum control speeds for the maximum thrust for the relevant flight phase, in which case the controllability of the aircraft is no longer an issue when thrust is increased. In this embodiment, the pilot has a means at his disposal for obtaining the maximum thrust from all engines. The input means in this and the following embodiment described may be take various forms, for example, a knob or a switch on a throttle lever, or a position of a throttle lever, or be designed in such a manner that the pilot is required to apply a force and/or perform a particular operation in order to place the throttle lever into the respective position and/or hold it there.

In one embodiment with a device according to the present invention, an input means is applied in order to adjust the thrust of an engine to an automatic predetermined maximum controllable thrust of the engine during a takeoff and/or subsequent climb procedure. In this embodiment, upon detecting an input on the input means, a processing unit determines at which thrust level an engine the aircraft is still controllable in the event of an engine failure: based upon the speed of the aircraft, whether or not corrected and/or with the application of incremental increases, the upper limits of the V_{mcg} and/or the V_{mca} are determined, whereupon the maximum controllable thrust for each of the engines is determined depending on the specific flight phase and the predetermined V_{mcg} and/or V_{mca}. The thrust of each engine is then automatically increased by the device to the maximum controllable thrust determined for that engine. To determine the maximum controllable thrust, in one embodiment use is made of a parameter such as a thrust, a speed, a temperature and/or an air pressure. In order to obtain any of the parameters, in one embodiment use is made of an engine control computer, an air data computer and/or a pitot-static system.

In one embodiment with a device according to the present invention an adjustable transmission is applied between the thrust of an engine thrust and a thrust level display for the pilot.

In existing systems a thrust level display, such as a bar indication or a dial indication on a display screen is depicted depending on the absolute, the maximum or a normalized thrust level of an engine. In one device according to the present invention, the preset thrust levels of the engines can be different during a takeoff, which leads to individually divergent visual indications in the existing devices. A pilot is accustomed to visual thrust displays of the engines which give (almost) equal indications during a takeoff; this enables a pilot, for example, to quickly identify an engine failure. In this embodiment, a transmission between the thrust level of an engine and a thrust display is arranged in such a manner that during a takeoff according to the differentiated takeoff thrust method, wherein the engines deliver the preset thrust, the visual thrust displays for the engines are (almost) equal when unequal preset thrust levels are set for each of the engines.

In one embodiment, a predetermined transmission between the thrust of an engine and a thrust display is dependent on a preset thrust level. In one embodiment, a predetermined transmission between the thrust of an engine and a thrust display is dependent on an input on an input panel.

### BRIEF DESCRIPTION OF THE DRAWINGS

In the following, the method according to the present invention will be explained in further detail by means of an exemplary embodiment with reference to the appended drawings, wherein

FIG. 1 shows a representation of an aircraft during a takeoff using the differentiated takeoff thrust method with a corresponding force schematic;

FIG. 2 shows a representation of the aircraft of FIG. 1 with an engine failure and corresponding force schematic; and

FIG. 3 shows a schematic representation of the aircraft of FIG. 1 with the individual elements of the device according to the present invention.

### DETAILED DESCRIPTION OF EXEMPLARY EMBODIMENTS

The invention relates to a method for propelling an aircraft 1, using the differentiated takeoff thrust method, wherein the engines M1 and M4, mounted farthest from the symmetry plane provide less thrust during a takeoff from runway A than the engines M2 and M3 mounted closer to the symmetry plane, wherein the symmetry plane is defined as the plane through the longitudinal axis L and the top axis T of the aircraft.

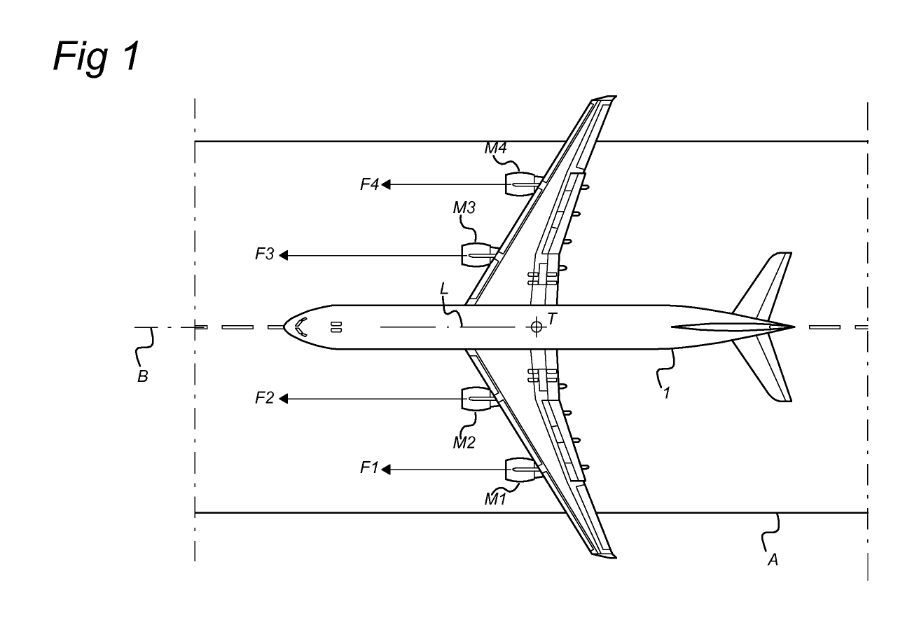

FIG. 1 shows aircraft 1 during a takeoff from runway A, wherein the engines M2 and M3 generate a thrust F2 and F3 respectively, and engines M1 and M4 generate a thrust F1 and F4 respectively. The distribution of thrust between the different engines is symmetric: F1 is equal to F4, and F2 is equal to F3. The thrust distribution is differentiated: F1 and F4 are different from F2 and F3. The thrusts are dependent on the distance to the symmetry plane: F1 and F4 are, with the respective distances D1 and D4 to the symmetry plane, less than F2 and F3, with the respective distances D2 and D3 to the symmetry plane.

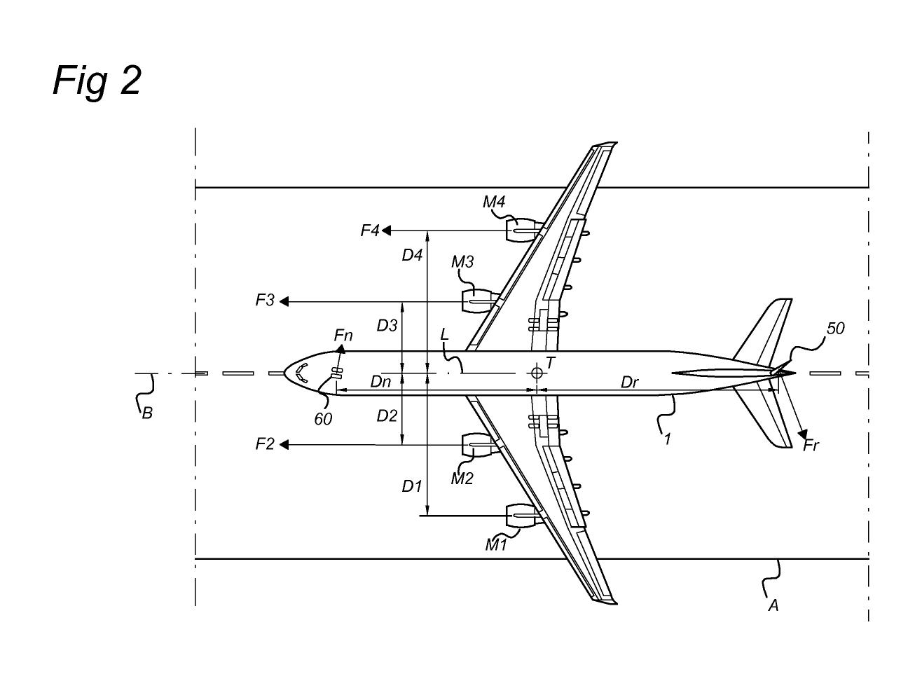

FIG. 2 shows a representation of aircraft 1 during a takeoff wherein engine M1 has failed. The thrust F4 of engine M4 has a destabilizing effect on the aircraft in the form of a moment about the top axis T with a magnitude of F4 times D4. This moment will cause the aircraft 1 to deviate (to the left) from the runway axis B. To counteract this moment and to enable the pilot to steer the aircraft 1 on or in close proximity to the runway axis B, by means of deflection of the rudder controls by the (automatic) pilot, the rudder 50 and the nose wheel 60 are deflected, thus generating an aerodynamic force Fr on the rudder 50 and frictional force Fn on the nose wheel 60. The components of Fr and Fn perpendicular to the symmetry plane, in conjunction with the respective distances Dr and Dn to the top axis T, cause a moment about the top axis T which is opposed to the destabilizing moment.

With the method and the device according to the present invention the engines M1 and M4 provide less thrust during the takeoff than the engines M2 and M3. Because the moment about the top axis determines the V_{mcg} and V_{mca} and not the thrust, the engines M2 and M3 may provide a thrust which is a maximum of D1/D2 more than the thrust of the engines M1 and M4 at a constant V_{mcg} and V_{mca}. By applying a thrust differential between the engine combinations M1-M4 and M2-M3, on takeoff the engines provide more thrust jointly than in the existing derated takeoff thrust method, wherein the engines M2 and M3 provide thrust equal to that of the engines M1 and M4. By the increased thrust of the engines M2 and M3 the runway-length limited takeoff weight is increased on a short and/or slippery runway, thus enabling a takeoff with a higher payload and/or fuel load than a takeoff according to the derated takeoff thrust method or with a takeoff according to the maximum takeoff thrust method.

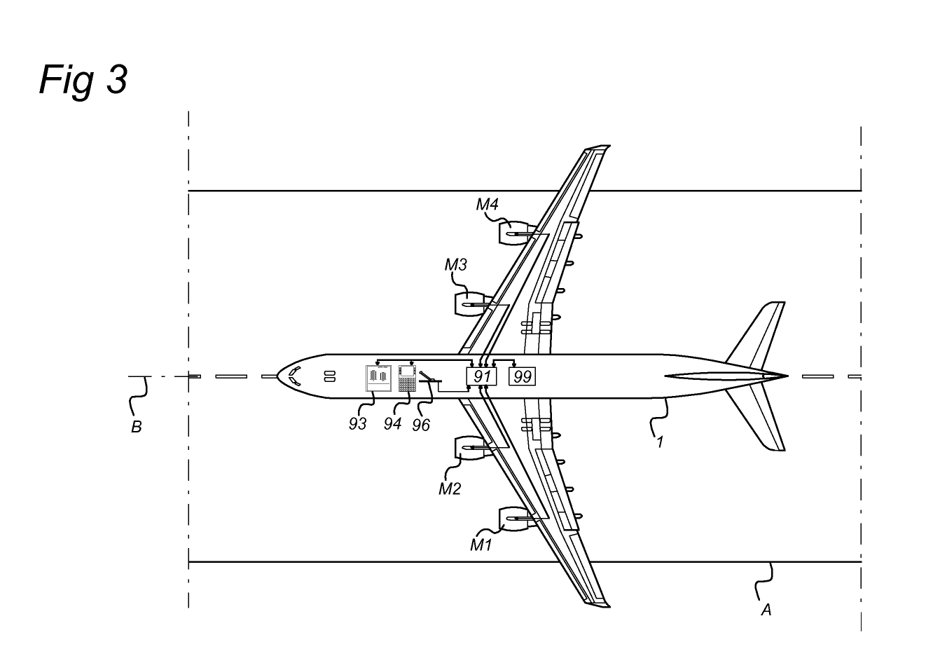

When the differentiated takeoff thrust method is applied, in this embodiment the pilot may input a limited number of thrust levels for the engines M1 and M4 on the input panel 94 (see FIG. 3) in the form of a preset thrust level. With the input of a thrust level the pilot initiates the central processing unit 91 for a takeoff method according to the differentiated takeoff thrust method.

Prior to departure, the pilot determines the optimal thrust for engines M1 and M4, with the corresponding runway-length limited takeoff weight and the corresponding minimum control speeds derived from various data and tables specific to each of the selectable thrust levels that correspond to the differentiated takeoff thrust method based on practical trials and arithmetical methodology. In the present embodiment, with the use of the differentiated takeoff thrust method, the thrust level of the engines M2 and M3 is permanently set to the maximum thrust. The pilot determines the takeoff speeds to be used during the takeoff according to the selected thrust levels for the engines, the actual takeoff weight, the prevailing atmospheric conditions and the wind and enters the preset thrust levels for engines M1 and M4 on the input panel 94. This input of the thrust levels for the engines M1 and M4 is used by the device to automatically set the thrust levels of the engines M2 and M3 to the maximum thrust during the takeoff.

The selectable thrust levels for engines M1 and M4 are determined in this embodiment in such a manner that when the differentiated takeoff thrust method is applied the preset thrust level of the engines M1 and M4 can never be less than D1/D2 times the maximum thrust level of the engines M2 and M3. In this embodiment, the preset thrust level of the engines M1 and M4 can only be input or modified on the ground prior to the startup of the engines M1 and M4, as determined by an altitude from radio altimeter 99 and data from the engine control computers of the engines M1 and M4.

On a display means 93 (for example, in the form of a display screen), which displays the most important engine data during the flight, the preset thrust levels for all engines are displayed by the device prior to and during the takeoff procedure. Before commencing the takeoff the pilot verifies that the prevailing weather conditions, takeoff weight and runway conditions do not exceed limits assumed in the calculations.

With the device according to the present invention use is made of 4 discrete selectable (adjustable) throttle levers 96 (see FIG. 3). Commencement of the takeoff is determined by the central processing unit 91 based upon the throttle lever position set by the pilot in accordance with a method according to the present invention. After setting the position of the throttle levers, the central processing unit 91 controls the engines by means of an electronic engine control unit of each of the engines based upon the maximum thrust for the engines M2 and M3, and the preset thrust level for engines M1 and M4. The electronic engine control unit, for example, can be a system based upon a data processor that forms an integrated part of engine M1-M4.

At a predetermined altitude derived from radio-altimeter 99, if no engine failure is detected by any of the engine control modules this data is transmitted to the central processing unit 91 and the central processing unit 91 sets all engines via the individual engine control modules to a climb thrust level if this is less than the preset thrust level for the respective engine during takeoff. Upon detection of an engine failure, at the command of the pilot via an input on input means (input panel) 94, the central processing unit 91 sets the operative engines to the maximum continuous thrust level if this is less than the preset thrust level of the respective engine during takeoff.

In the above description a processing unit is understood to be an arithmetic data processing unit, such as a software-operated computer, where necessary provided with corresponding digital and/or analogue circuits. A computer may be provided with a separate processing unit, but also with multiple, simultaneously operating processing units, if so desired. Furthermore, a computer may be provided with remote functionality, wherein data processing is performed at different locations situated at a distance from each other.

In the above description the “thrust” of an engine is used to designate the unit of propulsion of an aircraft. In propeller-driven aircraft, for example, it is customary to use “engine power” to designate the unit of propulsion. For the sake of clarity, in this text the term “thrust” has been chosen to designate the exclusive use of thrust as the unit of propulsion. Thrust is interchangeable in the text with other units of propulsion of an aircraft commonly used in aviation, which include, for example (but not limited thereto): engine power, engine rpm (for example the rpm of the main rotor of an engine) or pressure difference (for example a pressure difference between an inlet pressure and an outlet pressure of an engine).

It will be apparent to the skilled person that various modifications and changes are conceivable in relation to the above-described embodiments of the method and/or device according to the invention.

Among other things, the processing unit 91 is designed to perform arithmetic operations, for example in the form of a computer software product provided with instructions that can be executed by a computer. To this end, the processing unit 91 is provided with one or more processors and data memory components (such as a hard disk and/or semiconductor-based memory). The processing unit 91 is also connected to means for the input of instructions, data, etc. by a user, such as the above-mentioned display screen 93 and input panel 94. A keyboard, a mouse and other data input means such as a touch screen, a track ball and/or voice converter, which are all known to the skilled person, can also be applied.

A reading unit coupled to the processing unit 91 can be provided in order to read computer executable instructions into the memory of the processing unit. If so desired, the data reading unit can be arranged to read from or save data to a computer program product, such as a floppy disk or a CDROM. Other similar data media include, for example, memory sticks, DVDs, blue-ray disks, as known to the skilled person.

The processor(s) in the processing unit 91 can be implemented as a standalone system or as a number of parallel operating processors, each of which is arranged to perform subtasks of a larger program, or as one or more main processors with various sub-processors.

1. Method for propelling an aircraft, comprising three or more engines (M1-M4) for propelling the aircraft (1); and data processing means (91) coupled to the engines (M1-M4), wherein the data processing means (91) are arranged to control one or more engines (M1-M4) according to a preset thrust level, wherein a preset thrust level represents a desired thrust level of one engine or more engines (M1-M4) of the aircraft (1),
characterised in that during a takeoff of the aircraft (1) a symmetrical thrust is applied, wherein at least one engine (M1-M4) provides less thrust than the maximum thrust of the engine (M1-M4), and wherein at least one engine mounted further from the symmetry plane of the aircraft (M1, M4) provides less thrust than an engine mounted closer to or on the symmetry plane (M2, M3).

2. Method for propelling an aircraft according to claim 1, wherein the maximum thrust of an engine (M1-M4) is applied as a preset thrust level of an engine (M1-M4) during takeoff.

3. Method for propelling an aircraft according to claim 1, wherein a selected thrust level is applied as a preset thrust level of an engine (M1-M4) during takeoff.

4. Method for propelling an aircraft according to claim 1, comprising input means (94) for the input of a preset thrust level, wherein a preset thrust level represents the desired thrust of an engine (M1-M4) during takeoff.

5. Method for propelling an aircraft according to claim 1, wherein the processing means (91) are further arranged to automatically determine a preset thrust level, wherein a preset thrust level represents a desired thrust level of an engine (M1-M4) during takeoff.

6. Method for propelling an aircraft according to claim 1, comprising input means (94) for the input of a change command for the thrust level of an engine (M1-M4), wherein an input is applied in order to change a preset thrust level to the maximum thrust of an engine (M1-M4).

7. Method for propelling an aircraft according to claim 1, comprising
input means (94) for the input of a change command for the thrust level of an engine (M1-M4); and
means for determining a speed of the aircraft (1);
wherein the processing means (91) are coupled to the means and input means (94) and are further arranged to determine automatically, according to a speed of the aircraft (1), a maximum controllable thrust of an engine (M1-M4) wherein the aircraft (1), in the event of an engine failure, is still controllable, wherein an input is applied in order to change a preset thrust level to an automatically predetermined maximum controllable thrust level of an engine (M1-M4).

8. Method for propelling an aircraft according to claim 1, comprising
an adjustable throttle lever (96) for the input of a preset thrust level, wherein the preset thrust level represents the desired thrust level of an engine (M1-M4);
wherein the processing means (91) are coupled to the throttle lever (96) and an engine (M1-M4), wherein the processing means (91) are further arranged to control an engine (M1-M4) or a combination of engines (M1-M4), based upon the position of the throttle lever (96) and a preset transfer function, wherein the transfer function represents the relationship between the position of a throttle lever (96) and the preset thrust level of an engine (M1-M4), wherein the transfer function between the position of a throttle lever (96) and the thrust of an engine (M1-M4) is adjustable.

9. Method for propelling an aircraft according to claim 8, comprising input means (94) for the input of a transfer function, wherein the input of the transfer function is used for a preset transfer function between the position of a throttle lever (96) and the thrust of an engine (M1-M4).

10. Method for propelling an aircraft according to claim 8, wherein the processing means (91) are arranged to automatically determine a transfer function based upon a preset thrust level of an engine (M1-M4), wherein the automatically determined transfer function is applied for a preset transfer function between the position of a throttle lever (96) and the thrust level of an engine (M1-M4).

11. Method for propelling an aircraft according to, wherein a preset thrust level is applied in order to derate the thrust level of an engine during (M1-M4) a takeoff.

12. Method for propelling an aircraft according to claim 11, wherein a preset thrust level is applied in an engine control unit of an engine (M1-M4) in order to derate the thrust of an engine (M1-M4).

13. Method for propelling an aircraft according to claim 11, wherein a preset thrust level is applied in a processing unit (91) for controlling an engine control unit of an engine (M1-M4) in order to derate the thrust of an engine (M1-M4).

14. Method for propelling an aircraft according to claim 1, comprising
a display means (93) to display the thrust level of an engine (M1-M4);
an engine (M1-M4) for propelling an aircraft (1);
wherein the processing means (91) are coupled to a display means (93) and an engine (M1-M4), wherein the processing means (91) are further arranged to control a display means (93) based upon the thrust level of an engine (M1-M4) and a predetermined transfer function, wherein the transfer function represents the relationship between the thrust level of an engine (M1-M4) and a display on a display means (93), wherein the transfer function between the thrust level of an engine (M1-M4) and a display on a display means (93) is adjustable.

15. Method for propelling an aircraft according to claim 14, comprising input means (94) for the input of a transfer function, wherein the input of the transfer function between the thrust level of an engine (M1-M4) and a display on a display means (93) is used for a preset transfer function.

16. Method for propelling an aircraft according to claim 14, comprising processing means (91) that are arranged in order to automatically determine a transfer function based upon a preset thrust level of an engine (M1-M4), wherein the automatically determined transfer function is used for a predetermined transfer function between the thrust level of an engine (M1-M4) and a display on a display means (93).

17. Method for propelling an aircraft according to claim 1, wherein data from an air data computer is used.

18. Method for propelling an aircraft according to claim 1, wherein a pitot-static system is used.

19. Method for propelling an aircraft according to claim 1, wherein a remote processing unit (91) is used.

20. Method for propelling an aircraft according to claim 1, wherein a wireless data communication link is used.

21. Method for propelling an aircraft according to claim 1, wherein an input means (94) is used for the input of data.

22. Method for propelling an aircraft according to claim 1, wherein an automated data file is applied.

23. Method for propelling an aircraft according to claim 1, wherein an automated system is applied in order to determine the weight of the aircraft.

24. Method for propelling an aircraft according to claim 1, wherein an engine power is used instead of a thrust.

25. Method for propelling an aircraft according to claim 1, wherein an rpm of an engine part is applied instead of a thrust.

26. Method for propelling an aircraft according to claim 1, wherein a pressure or a pressure ratio in an engine is used instead of a thrust.

27. Method for propelling an aircraft according to claim 1, wherein a takeoff speed and/or a minimum control speed is determined automatically.

28. Processing means (91) coupled to three or more engines (M1-M4) for propelling an aircraft (1), wherein the processing means (91) are arranged to control one or more engines (M1-M4) according to a preset thrust level, wherein the preset thrust level represents a desired thrust of one or more engines (M1-M4) of the aircraft (1),
characterised in that the processing means (91) are arranged in order to control the one or more engines (M1-M4) in order to apply a symmetrical thrust during takeoff of the aircraft (1), wherein at least one of the engines (M1-M4) provides less thrust than the maximum thrust of this engine, and wherein at least one of the engines (M1-M4) mounted further from the symmetry plane of the aircraft provides less thrust than an engine mounted closer to or on the symmetry plane (M2, M3).

29. (canceled)

30. Computer software product provided with instructions to be executed by a computer so that when read into a processing unit (91), the processing unit (91) provides the functionality of the method according to claim 1.
